(19) United States
(12) Patent Application Publication
(10) Pub. No.: US 2007/0271337 A1
(43) Pub. Date: Nov. 22, 2007

(54) Quorum for a Real-Time, Collaborative Electronic Meeting

(75) Inventor: Sean C. Olson, Duvall, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/419,726

(22) Filed: May 22, 2006

(51) Int. Cl. G06F 15/16

(52) U.S. Cl. 709/204

(57) ABSTRACT

This document describes tools that notify participants of a real-time, collaborative electronic meeting when the meeting productively starts. To do so, the tools may build a quorum of events that need to occur before the meeting may productively start. These events may include a particular person joining the meeting, such as the meeting's lead presenter, a particular document being uploaded for the participants to see or use, such as a PowerPoint™ presentation, an agenda for the meeting, and the meeting's start time, to name a few. When the tools determine that the events have occurred, the tools notify the participants. This permits participants of a meeting to focus on things other than the meeting until the meeting productively starts.

### BACKGROUND

Currently, participants in a real-time, collaborative electronic meeting often waste time waiting for the meeting to productively start. A meeting may be scheduled for 1 p.m., for instance, and three participants may join at 1 p.m., but if the speaker has not joined or some necessary document has not been distributed, the meeting may not be productive. So, while the meeting may have started by having participants, it will not have productively started. This waiting time may be especially wasteful for participants in electronic meetings because many participants are on their computers, where they can do other things if they are not waiting for a meeting to productively start.

### SUMMARY

This document describes tools that notify participants of a real-time, collaborative electronic meeting when the meeting productively starts. To do so, the tools may build a quorum of events that need to occur before the meeting may productively start. These events may include a particular person joining the meeting, such as the meeting's lead presenter, a particular document being uploaded for the participants to see or use, such as a PowerPoint™ presentation, an agenda for the meeting, and the meeting's start time, to name a few. When the tools determine that the events have occurred, the tools notify the participants. This permits participants of a meeting to focus on things other than the meeting until the meeting productively starts.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTION OF THE DRAWINGS

FIG. 1 illustrates an exemplary operating environment in which various embodiments of the tools may operate.

FIG. 2 illustrates an exemplary central communication topology.

FIG. 3 illustrates an exemplary distributed communication topology.

FIG. 4 is an exemplary flow diagram showing one way in which the tools may act to build a quorum.

FIG. 5 is an exemplary a time-flow graph showing one example of the tools interacting with participants to notify them that a meeting is ready to productively start in a central communication topology and using elements of FIGS. 1 and 2 and quorum events of FIG. 4.

FIG. 6 is an exemplary process illustrating various embodiments and manners in which the tools may notify persons or entities that a real-time, collaborative electronic meeting is or has productively started.

The same numbers are used throughout the disclosure and figures to reference like components and features.

### DETAILED DESCRIPTION

### Overview

The following document describes tools capable of enabling participants in a real-time, collaborative electronic meeting to know when the meeting productively starts. To do so, the tools may build a quorum of events that need to occur before the meeting may productively start and notify participants when all of those events have occurred. These tools may do so in distributed, centralized, or combined communication topologies.

An environment in which the tools may enable these and other actions is set forth below in a section entitled Exemplary Operating Environment. This is followed by another section describing one exemplary way in which the tools may act to build a quorum and is entitled Building an Exemplary Quorum. Another section follows and describes using the built quorum in a central communication topology to notify participants when the meeting productively starts and is entitled Example in a Central Communication Topology. A final section describes these and other embodiments and manners in which the tools may act in a centralized, distributed, or combined communication topology and is entitled Other Embodiments of the Tools. This overview, including these section titles and summaries, is provided for the reader's convenience and is not intended to limit the scope of the claims or the entitled sections.

### Exemplary Operating Environments

Before describing the tools in detail, the following discussion of exemplary operating environments is provided to assist the reader in understanding some ways in which various inventive aspects of the tools may be employed. The environments described below constitute examples and are not intended to limit application of the tools to any one particular operating environment or communication topology. Other environments and topologies may be used without departing from the spirit and scope of the claimed subject matter.

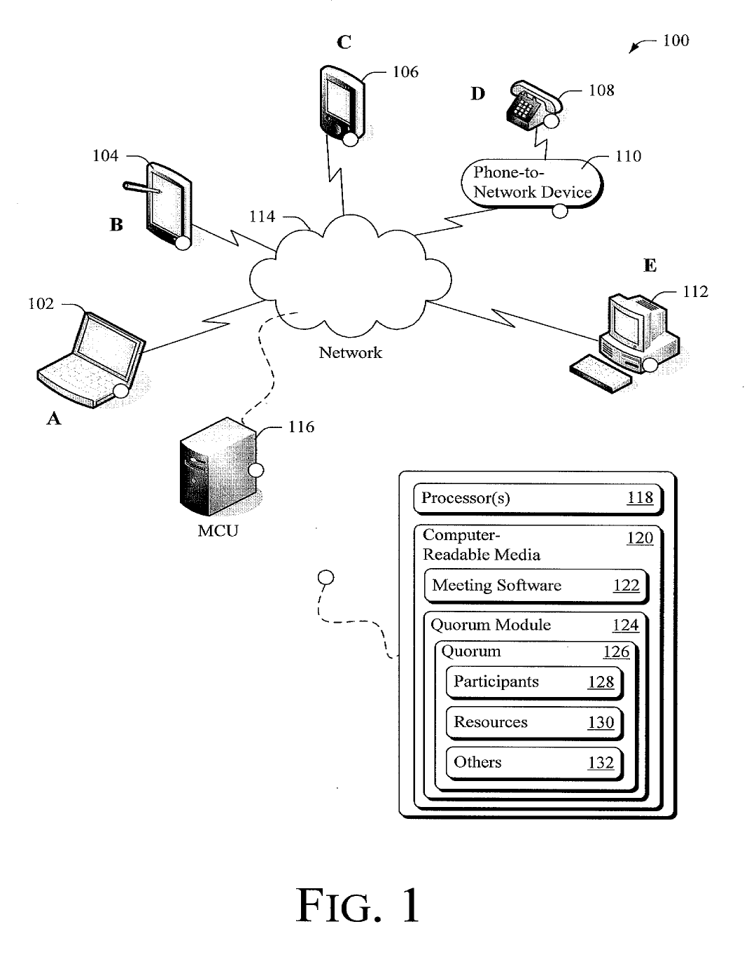

FIG. 1 illustrates one such operating environment generally at 100 having five meeting participants, participant A shown communicating with a communication device 102, participant B shown communicating with a communication device 104, participant C shown communicating with a communication device 106, participant D shown communicating with a telephone 108 connected to a phone-to-network communication device 110, and participant E shown communicating with a communication device 112.

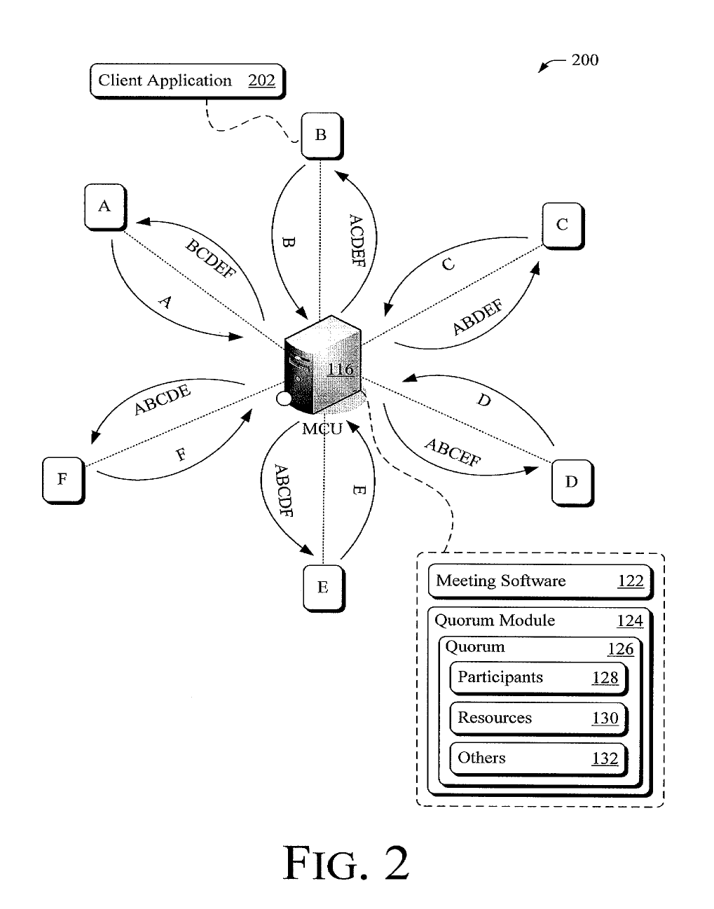

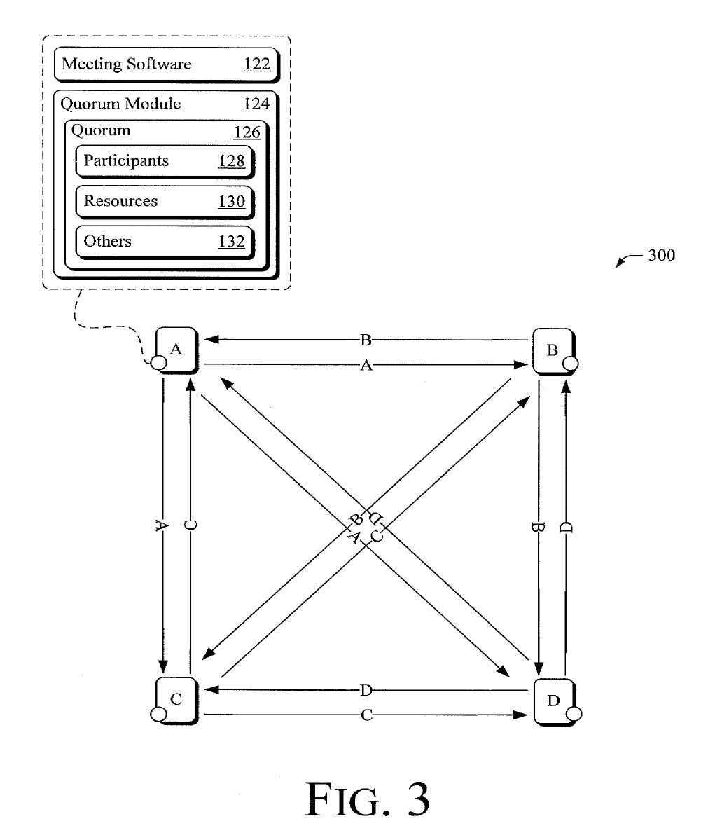

The environment also has a communications network 114, such as a company intranet or a global internet (e.g., the Internet) and in some cases has access to a server 116. The participants' devices may be capable of communicating directly to the network (e.g., a wireless-Internet enabled laptop, PDA, or a Tablet PC, a wired Internet-enabled desktop computing device, or VoIP-enabled telephone or cellular phone wired or wirelessly connected to the Internet) or indirectly (e.g., the telephone connected to the phone-to-network device). The meeting may be enabled through a distributed (e.g., peer-to-peer) or central network topology (or a combination of these). Exemplary distributed and central network topologies are illustrated in FIGS. 2 and 3 and described below.

The server 116 and/or any of these devices, including the phone and the phone-to-network device, may be a computing device having one or more processor(s) 118 and computer-readable media 120 (each device and the server marked with “◯” to indicate this possibility). The processor(s) are capable of accessing and/or executing the computer-readable media. The computer-readable media comprises meeting software 122 and a quorum module 124.

The meeting software and the quorum module may be integral (not shown) or separate. The module is capable of building and/or using the quorum to notify participants (or others) that a meeting has productively started. The quorum module comprises, indicates, or has access to a quorum 126 with quorum events related to one or more of participants 128, resources 130, and others 132. Note that the term “participants” is sometimes used interchangeably herein with the communication device used by the participants, as will be apparent by the context.

FIG. 2 illustrates an exemplary central communication topology 200 in which elements of environment 100 and other elements may act. Here audio and/or video media is passed from each participant A through F to a meeting MCU (Multipoint Control Unit) on server 116. Participant A's device, for example, may send audio (e.g., spoken by participant A) to the server and receive audio and/or video (e.g., streaming media of a meeting leader speaking) from each of the other participants through the server. This is shown with an “A” being sent to the server and the “BCDEF” being sent back. Note that the server comprises or has access to meeting software 122 and quorum module 124.

Here the meeting software acts as a central manager that manages the meeting, keeps track of participants in a roster, receives uploaded documents and distributes them to participants, and other actions of conferencing software applications know to those skilled in the art. The meeting software in this central communication topology interacts with a client application 202 on each of the participant's computing devices (shown comprised by participant B's device but comprised by each of the participant's devices). The client applications may each interact with the meeting software on the server to send and receive media and documents, make notifications (e.g., those ordered by the quorum module), present a user interface for the meeting having media and documents, and in other manners known to those skilled in the art.

FIG. 3 illustrates an exemplary distributed communication topology 300 in which elements of environment 100 and other elements may act. Here audio and/or video media is passed from each participant A through D to each other participant through the communication network, either directly or through Network Address Translators (NATs) or media relays or a combination thereof. Participant B, for example, passes his or her media and/or documents to each participant A, C, and D (sending and receiving is shown with arrows). In this distributed topology, there are multiple instances of the meeting software and quorum module executed by the communication device of each participant (e.g., a participant's laptop). This is shown with the “◯” marked at each of the participants/devices and with one example for participant A.

### Building an Exemplary Quorum

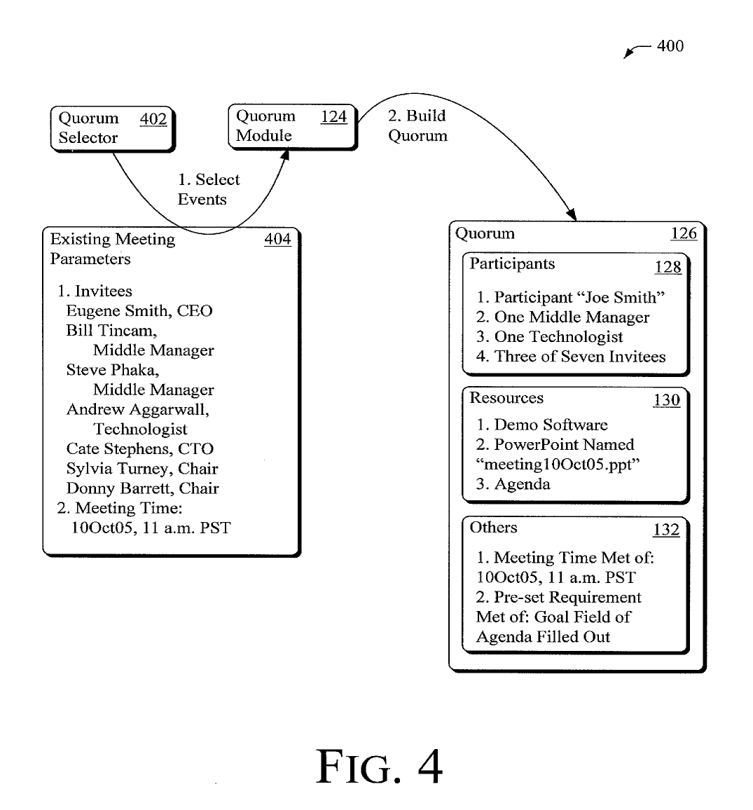

In this section elements of FIG. 1 and a person are used to describe one exemplary way in which the tools may act to build a quorum. This example is an implementation of the tools but is not intended to limit the scope of the tools or the claimed embodiments. This example is illustrated in FIG. 4, which illustrates a flow diagram 400 of a quorum event selector 402 and quorum module 124 interacting to build quorum 126 in part using existing meeting parameters 404.

At arrow 1, the quorum selector selects quorum events. The selector may submit quorum events or indicate existing parameters of an existing meeting as quorum events (shown with arrow 1 passing through parameters 404). Here a person named Andrew (e.g., Participant A through device 102) selects the following events to be quorum events:

Participants:
Participant “Eugene Smith”
One Middle Manager
One Technologist
Three of Seven Invitees

Resources:
Demo Software
PowerPoint Named “meeting 10Oct05.ppt”
Agenda

Others:
Meeting Time Met of: 10Oct05, 11 a.m. PST
Pre-set Requirement Met of: Goal Field of Agenda Filled Out

Here we assume that the meeting was already set up with seven invitees (i.e., permitted participants) and the meeting time. Andrew selected to make the meeting time a quorum event so that the quorum would not be met and thus the participants not notified until at least 11 a.m. on October 10^{th}. This was to insure that even if everything was ready before 11 a.m. that the meeting would not be notified as productively starting until then.

Andrew also selected that three of the seven invitees be present, perhaps because a vote needs to be made during the meeting and requires this number present for a valid vote. Andrew also selected Eugene Smith, one middle manager, and one technologist be participating in the meeting before the quorum is met. Note that here this means that either Bill Tincam or Steve Phaka needs to be present and that both Joe Smith and Andrew Aggarwall must be present (Andrew because he is the only technologist invited, not because he is also the quorum selector).

Andrew selected these quorum events by indicating that these meeting parameters are to be made quorum events, such as by clicking on the text for the meeting time, Joe Smith, Middle Manager, Technologist, and noting that three of the seven are required. Here the existing meeting parameters are presented by the meeting software in conjunction with the quorum module.

For the other quorum events Andrew defined the events by entering the particular event, here executable demonstration software (Demo Software), a particular PowerPoint™ document (one named “meeting10Oct05.ppt”), an agenda (not a particular one), and that a data-entry field in the agenda be filed out:
Demo Software
PowerPoint Named “meeting10Oct05.ppt”
Agenda
Goal Field of Agenda Not Null

Also at arrow 1, all of these quorum events are received by quorum module 124. At arrow 2, the quorum module builds a quorum for the meeting. Here the quorum events are arranged into participants 128, resources 130, and others 132, all of which are shown in FIG. 4. This quorum will be used in part as an aid in describing ways in which a quorum is used below. In one embodiment, for example, the quorum module builds the quorum using an extension of a Session Initiation Protocol (SIP) Event Package for Conference State.

To do so, the quorum module adds an XML element “<quorum>” to a conference/meeting description element “<conference-description>”, which references all of the quorum events in the quorum. This quorum element contains a list of references (e.g., XPath expressions) referring to invitees (e.g., with elements named “<users>”) or resources and others (e.g., both with elements named “<resources>”).

### Example in a Central Communication Topology

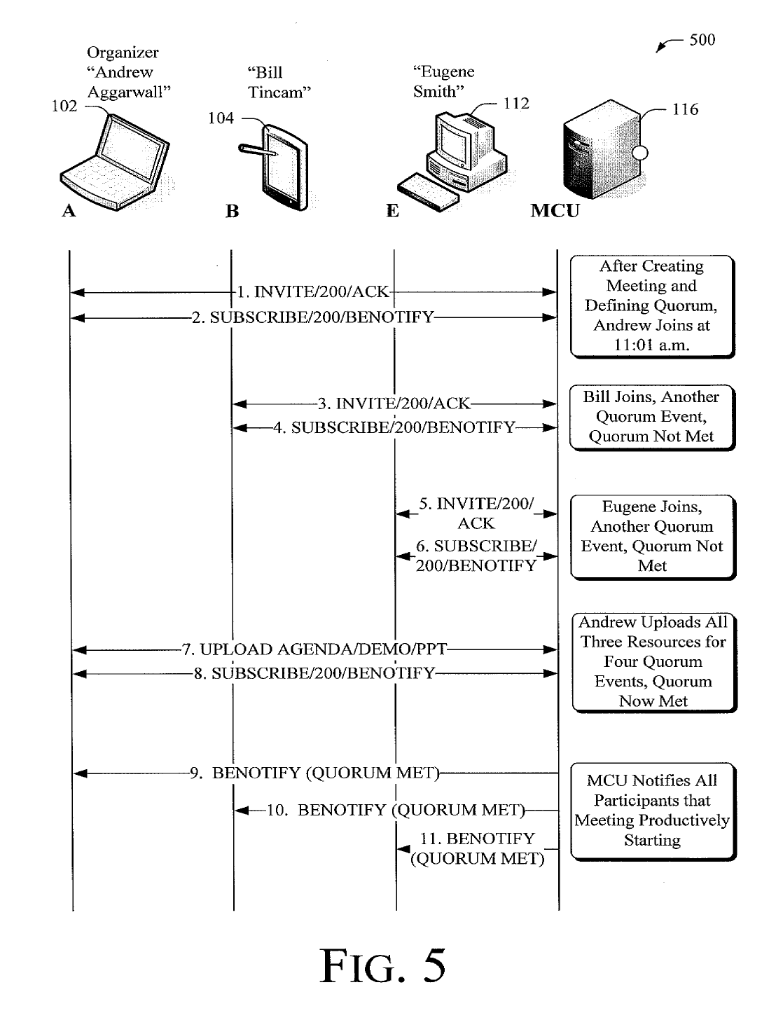

FIG. 5 illustrates a time-flow graph 500 for a meeting in which the example quorum of FIG. 4 is used. This graph shows one example of the quorum module interacting with participants to notify them that a meeting is ready to productively start.

FIG. 5 shows three of the seven invitees noted above. These three are named “Andrew Aggarwall,” “Bill Tincam,” and “Eugene Smith.” These participants are examples of participants “A”, “B”, and “E” from FIG. 1 and use their communication devices 102, 104, and 112. These devices each use their own client application 202 shown in FIG. 2. FIG. 5 also shows MCU server 116 (which has meeting software 122 and quorum module 124 noted with “◯”). Each communication here is made using SIP (Session Initiation Protocol) or SIMPLE (Session Initiation Protocol for Instant Messaging and Presence Leveraging Extensions) and shown with an arrow between the participant's device and the server across a communication network (not shown).

At arrows 1 through 6, Andrew, Bill, and Eugene join the meeting hosted by the MCU server. Here doing so involves (through their devices and the meeting software) sending an invite, receiving an okay, and sending an acknowledgement in response to the okay. Here it also involves subscribing to the meeting through a subscription protocol (at arrows 2, 4, and 6).

When Andrew joins, two of the quorum events of the example in FIG. 4 are met. By way of review, the quorum includes the following quorum events:

Participants:
Participant “Eugene Smith”
One Middle Manager
One Technologist
Three of Seven Invitees

Resources:
Demo Software
PowerPoint Named “meeting10Oct05.ppt”
Agenda

Others:
Meeting Time Met of: 10Oct05, 11 a.m. PST
Pre-set Requirement Met of: Goal Field of Agenda Filled Out

The two met when Andrew joins include the one requiring that a technologist participate (here only Andrew qualifies) and the one requiring the meeting time of 11 a.m. on Oct. 10, 2005. As Andrew joined at 11:01 a.m., these two quorum events are met. These are marked in italics above.

The quorum module may indicate to Andrew or any non-participating invitees (or others) that two of the quorum events are met and/or which are still needed. This can be through the meeting software (to Andrew) or through other manners, such as an email to the other invitees. While not shown in the graph, here the quorum module interacts with an email server (e.g., Microsoft® Outlook™) to send emails to all of the other invitees telling them that Andrew has joined and which quorum events are still needed for the meeting to productively start. This may be useful in reminding other invitees about the meeting and what they may need to upload or other actions needed to meet the quorum.

When Bill joins at arrows 3 and 4 and Eugene joins at arrows 5 and 6, three more quorum events are met. These are also marked with italics in the example quorum below:

Participants:
Participant “Eugene Smith”
One Middle Manager
One Technologist
Three of Seven Invitees

Resources:
Demo Software
PowerPoint Named “meeting 10Oct05.ppt”
Agenda

Others:
Meeting Time Met of: 10Oct05, 11 a.m. PST
Pre-set Requirement Met of: Goal Field of Agenda Filled Out

When Bill joined, the “one middle manager” quorum event is met as both he and Steve Phaka are defined as being of that class of participant. When Eugene joined, the quorum event requiring that he specifically be participating was met. A third quorum event is also met, that of having three of the seven invitees present (Eugene represents the third invitee to participate). In this case this quorum event is redundant, as Bill or Steve, Eugene, and Andrew are all needed anyway. In many other cases it would not be redundant (e.g., requiring four participants).

At arrows 7 and 8 Andrew uploads various resources to the meeting software on the server. Andrew uploads the demo software, the PowerPoint™ document, and the agenda. These three uploads meet all of the resource quorum events, as noted above, but one last quorum event may still be needed. Here company policy requires that the Goal Field in the agenda be filled out and thus, that every meeting quorum has this filled out if that meeting has an agenda in its quorum. Here Andrew added a quorum event requiring this field to be filled out when he added an agenda to the quorum, though not explicitly.

At this point the quorum module analyzes the agenda to determine if that data-entry field is void or not. If not, the quorum event is met. The quorum module may do so in manners known in the art, such as by parsing a hierarchical data tree (e.g., eXtensible Markup Language data tree) for the agenda to find out if a node of the tree related to the data-entry field is null or filled out. The quorum module determines that this field is filled out with “Rundown of Software Bugs Found in Beta Testing” (not shown).

At arrows 9, 10, and 11, the quorum module (here through the software on the server) notifies each of the participants that the meeting has productively started. Andrew, Bill, and Eugene now know to focus on the meeting. The notification here is either through an audio indicator generated by each participant's device voicing: “Eleven AM meeting is now ready to start” and a visual indicator generated by each device's client application 202 flashing its meeting user interface or visual and audio indicators similar to those currently used to alert persons about a newly received email or instant message. The quorum module may also notify other invitees, such as Steve Phaka, Cate Stephens, Sylvia Turney, and Donny Barrett (see FIG. 4). Through this the other invitees may know that they need to join right away or they likely will miss a productive portion of the meeting.

### Other Embodiments of the Tools

The above section describes manners in which the tools may act to notify participants of a real-time, collaborative electronic meeting arranged in a central communication topology that a meeting is productively starting. Below these and other embodiments of the tools are provided that may be implemented in a centralized, distributed, or combined communication system.

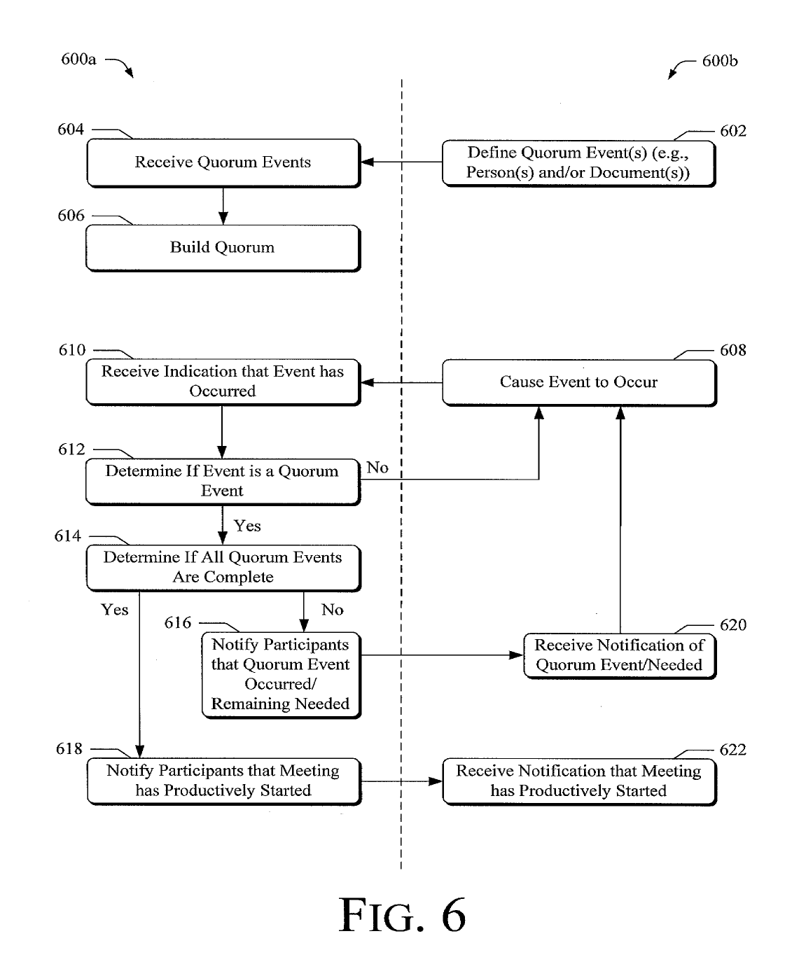

These exemplary embodiments are described as part of two processes 600a and 600b of FIG. 6. These processes of FIG. 6 and the exemplary actions related to FIGS. 4 and 5 may be implemented in any suitable hardware, software, firmware, or combination thereof; in the case of software and firmware, these processes and actions represent sets of operations implemented as computer-executable instructions stored in computer-readable media and executable by one or more processors. These embodiments of the tools are not intended to limit the scope of the tools or the claims.

These processes 600a and 600b are separated by a dashed line through which remote entities communicate over a communication network, such as network 114 of FIG. 1. Process 600a shows actions of a distributed communication topology entity (e.g., quorum module 124 acting through any participant's communication device 102, 104, 106, 110, or 112 of FIG. 1), a combined topology entity (e.g., quorum module 124 acting through a server, distributed client device, or other device), or a centralized communication topology entity (e.g., quorum module 124 of MCU server 116 of FIG. 1). Process 600b shows actions of a participant through his or her communication device. The entity of process 600b in a central communication topology may be a communication device's client application 202. In a distributed communication topology the entity of process 600b may also by client application 202 or be quorum module 124 and/or meeting software 122 executing on participant's communication device.

Prior to or concurrent with block 602, someone sets up the meeting. This person may set up the meeting by deciding when it starts, who is invited (i.e., the permitted participants), uploading documents or noting documents that are desired to be uploaded at some point, and uploading an agenda or template for an agenda to be filled out later. In response the tools may send an email to those people that are invited, which may include a hyperlink to join the meeting or otherwise interact with the meeting software (e.g., by uploading a document). Parameters used in setting up the meeting may also be quorum events, as noted above.

At block 602 a person defines one or more quorum events. These quorum events are those that must occur for a real-time, collaborative electronic meeting to productively start. The person may define the quorum events by entering them or with indicia of already listed events, for example. Events recorded for a meeting, such as a list of all invitees or to-be-uploaded documents, for example, may be defined as quorum events by selecting indicia associated with these events. The person may also indicate which quorum events are to be exposed to the participants. Thus, the person may indicate that participants or invitees (or some of them) should be notified about some quorum events not having been met but not others. Andrew in the above example in FIG. 4, for instance, may want participants to know that the meeting needs Eugene to join before it can productively start but not that the Agenda's Goal Field must first be filled in.

Quorum events may include, by way of example: a particular person of a set of persons permitted to participate in the meeting; a number of persons participating in the meeting of the set of persons permitted to participate in the meeting; a person of a class of persons permitted to participate in the meeting; a particular document or type of document (e.g., an agenda for the meeting); and a scheduled meeting time of the meeting, to name just a few. Note some examples of these quorum events are mentioned in the above exemplary embodiments, such as a particular person (“Eugene Smith”), a person of a class of persons (one middle manager of two possible middle managers), or a particular document (the demo software or the PowerPoint™ document).

Block 604 receives one or more quorum events. In the illustrated example of FIG. 4, it included nine quorum events of many different types. Block 604 may receive them as indicia associated with recorded or existing events (e.g., at the meeting software) or entered directly.

Block 606 builds the quorum. This quorum comprises quorum events and is usable to later notify persons that a meeting is productively starting or has productively started. The tools may build the quorum using the quorum module, such as in manners described in the illustrated examples above. The tools may later use the quorum during a realtime collaborative electronic meeting to determine when all of the quorum events have occurred.

At block 608 a person or entity causes an event to occur. For example, a person may join the meeting or upload a document. Or an entity may indicate that a meeting time is met (e.g., a clock).

Block 610 receives an indication that the event has occurred. This indication may be direct or indirect, such as when the quorum module receives an indication from the meeting software that a person permitted to participate in a meeting is now participating. Blocks 610, 612, 614, 616, and/or 618 may, in some embodiments, be performed automatically and without user interaction. Once an event has occurred, the tools may act to automatically notify participants when the quorum is met (or is not met).

Block 612 determines if an event is a quorum event. If it is not, the tools wait to receive another event and thus proceed to block 608. If it is, the tools proceed to block 614. Block 612 may compare the event to quorum events in the quorum. For example, if instead of Bill joining at arrows 3 and 4 of FIG. 5, Sylvia Turney joined, the tools may determine that no quorum event is met by her joining. The tools may determine that she is not a middle manager or Eugene Smith, for example. The tools would, however, note that she is the second person to join and use this information later if a certain number of participants is needed to meet a quorum event.

Block 614 determines if all of the quorum events of the quorum are met. If they are not, the tools proceed to block 616 (and/or 608). If they are met, the tools proceed to block 618. The tools may keep track of prior quorum events met and know which events are remaining. If the last remaining quorum event is met, then the quorum is complete. In the illustrated example above, the last quorum event met was a data-entry field not null in an agenda.

Block 616 notifies participants and/or others that a quorum event has occurred and/or that other quorum events are still needed. For the embodiments of FIGS. 4 and 5, for example, block 612 may determine that Bill has joined at arrows 3 and 4 and that he meets a quorum event. Responsive to this the tools may notify or indicate that because Bill joined, the quorum event requiring a middle-manager is met. The tools may also, for example, indicate quorum events that are not yet met with those that are. For example, the tools may provide the following for display to participants or others:

Participants:
Participant “Eugene Smith”—Not Met
One Middle Manager—Met by Bill Tincam
One Technologist—Met by Andrew Aggarwall
Three of Seven Invitees—Not Met, 1 more required

Resources:
Demo Software—Not Met
PowerPoint Named “meeting 10Oct05.ppt”—Not Met
Agenda—Not Met

Others:
Meeting Time of: 10Oct05, 11 a.m. PST—Met, Current Time 11:04 a.m.
Pre-set Requirement Met of: Goal Field of Agenda Filled Out—Not Met

The tools may also notify at regular intervals (e.g., every five minutes), when a person joins, or when a person or entity inquires. Following block 616, at block 620 a person or entity receives the notification from the tools, such as the above listing of quorum events met and not met.

Block 618 notifies participants and/or others that the meeting has productively started or is ready to productively start. The notification may be through a user interface associated with the meeting, such as through audio or visual manners noted in the example corresponding to FIG. 5, email, or in other manners of notifying persons known by a skilled artisan. The tools may notify the participants, a particular participant, all invitees, other persons, or entities (like a media program set to start a visual presentation at the moment the quorum is met).

At block 622 the person or entity receives the notification that the meeting has productively started.

### CONCLUSION

The above-described tools enable participants in a real-time, collaborative electronic meeting or other persons or entities to know when the meeting productively starts. The tools may do so in various types of communication topologies and permit participants of a meeting, for example, to focus on things other than the meeting until the meeting productively starts. Although the tools have been described in language specific to structural features and/or methodological acts, it is to be understood that the tools defined in the appended claims are not necessarily limited to the specific features or acts described. Rather, the specific features and acts are disclosed as exemplary forms of implementing the tools.

1. A method implemented at least in part by a computing device comprising:
determining that all of a quorum of one or more quorum events previously recorded as needed for a real-time, collaborative electronic meeting to productively start have occurred; and
notifying participants or invitees of said meeting that said meeting has productively started.

2. The method of claim 1, further comprising, prior to the acts of determining and notifying:
receiving from a person the one or more quorum events; and
building the quorum comprising the quorum events.

3. The method of claim 1, wherein the quorum events comprise one or more of: a particular person of the invitees of said meeting; a person of a class of persons of the invitees of said meeting; and a number of persons of the invitees of said meeting.

4. The method of claim 1, wherein the quorum events comprise a particular document or type of document.

5. The method of claim 4, wherein the particular document or type of document is an agenda for said meeting.

6. The method of claim 4, wherein the particular document or type of document comprises executable software.

7. The method of claim 1, wherein the quorum events comprise a scheduled meeting time of said meeting.

8. The method of claim 1, wherein one or more of the quorum events are caused to occur by one of the participants.

9. The method of claim 1, wherein the act of determining is responsive to receiving an indication that an event has occurred and comprises determining that the event is one of the quorum events of the quorum and that the quorum event is the last remaining quorum event of the quorum to be met.

10. The method of claim 1, wherein the act of notifying notifies the participants and comprises audio or visual indicia in each participant's user interface for said meeting.

11. The method of claim 1, further comprising, prior to the first-mentioned act of determining, receiving a first indication that a first event has occurred, determining that the first event is one of the quorum events of the quorum, and notifying the participants that the first event occurred.

12. The method of claim 1, further comprising, prior to the act of determining, a prior act of notifying the participants or invitees of a quorum event of the quorum needed to meet the quorum.

13. The method of claim 12, wherein the prior act of notifying is performed when each of the participants joins said meeting.

14. The method of claim 12, wherein the prior act of notifying comprises multiple acts of notifying that are performed at regular intervals.

15. The method of claim 1, wherein the method is performed automatically and without user interaction.

16. One or more computer-readable media having computer-readable instructions therein that, when executed by a computing device, cause the computing device to perform acts comprising:
receiving from a person one or more quorum events that must occur for a real-time, collaborative electronic meeting to productively start; and
building a quorum comprising the quorum events, the quorum usable by the computing device or another computing device and during the real-time collaborative electronic meeting to determine when all of the quorum events have occurred and said meeting may productively start.

17. The media of claim 16, wherein the quorum events comprise two or more of the following: a particular person of a set of persons permitted to participate in said meeting; a person of a class of persons permitted to participate in said meeting; a number of persons participating in said meeting of the set of persons permitted to participate in said meeting; an agenda for said meeting; a scheduled meeting time of said meeting; and a non-agenda document for use by participants of said meeting.

18. The media of claim 16, wherein the act of receiving receives indicia of events previously recorded, the indicia indicating which of the previously recorded events are the quorum events.

19. The media of claim 16, wherein the quorum is further usable by the computing device or the other computing device and during said meeting to determine which quorum events are those that participants of said meeting are to be notified as having occurred or needing to occur to meet the quorum.

20. One or more computer-readable media having computer-readable instructions therein that, when executed by a computing device, cause the computing device to perform acts comprising:
receiving from a person one or more quorum events that must occur for a real-time, collaborative electronic meeting to productively start, the quorum events comprising two or more of the following:
a particular person of a set of persons permitted to participate in said meeting;
a person of a class of persons permitted to participate in said meeting;
a number of persons participating in said meeting of the set of persons permitted to participate in said meeting;
an agenda for said meeting;
a scheduled meeting time of said meeting; and
a non-agenda document for use by participants of said meeting, building a quorum comprising the quorum events;
receiving an indication that at least two participants of said meeting have joined;
determining that all of the quorum events of the quorum have occurred; and
notifying, responsive to the act of determining, said participants of said meeting that said meeting has productively started.
